(19) United States
(12) Patent Application Publication
(10) Pub. No.: US 2026/0039398 A1
(43) Pub. Date: Feb. 5, 2026

(54) SYSTEM AND METHOD FOR HIGH-SPEED COMPONENT VERIFICATION WITHOUT INTRUSION

(71) Applicant: DELL PRODUCTS L.P., Round Rock, TX (US)

(72) Inventors: Jonathan F. Lewis, Round Rock, TX (US); Bhyrav Mutnury, Round Rock, TX (US)

(21) Appl. No.: 18/791,771

(22) Filed: Aug. 1, 2024

(51) Int. Cl. H04B 17/00; H04B 17/10

(52) U.S. Cl. CPC H04B 17/0085; H04B 17/104

(57) ABSTRACT

An information handling system including a first device, a second device, and a channel. The first device includes a transmitter for a high-speed data communication interface. The second device includes a receiver for the high-speed data communication interface. The channel is coupled between the transmitter and the receiver. The transmitter provides a test signal on the channel. The receiver receives the test signal from the channel, and determines a value of a component of the channel based on the received test signal.

### FIELD OF THE DISCLOSURE

This disclosure relates to information handling systems, and more particularly relates to verifying components in high-speed data communication interfaces in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system including a first device, a second device, and a channel. The first device includes a transmitter for a high-speed data communication interface. The second device includes a receiver for the high-speed data communication interface. The channel is coupled between the transmitter and the receiver. The transmitter provides a test signal on the channel. The receiver receives the test signal from the channel, and determines a value of a component of the channel based on the received test signal.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of a portion of a high-speed data communication interface according to an embodiment of the present disclosure;

FIG. 2 is a graph of the capacitive discharge of capacitors with various capacitance values in the high-speed data communication interface of FIG. 1;

FIG. 3 is a graph of the data eye width associated with capacitors with various capacitance values in the high-speed data communication interface of FIG. 1; and

FIG. 4 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

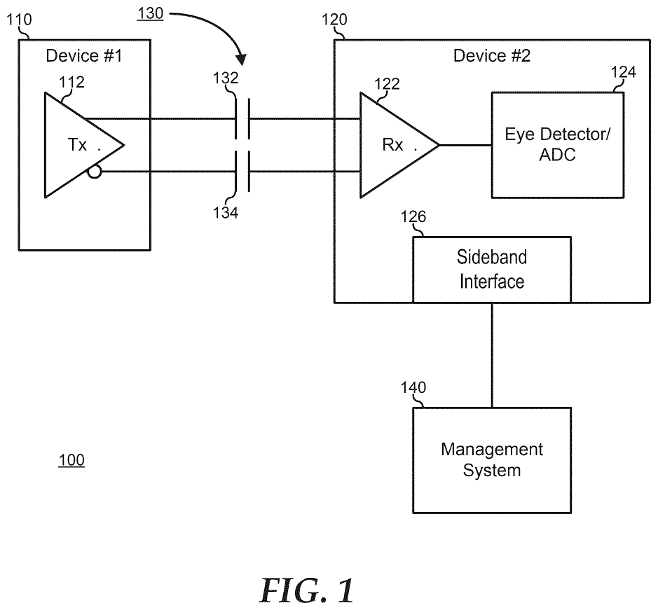

FIG. 1 illustrates a portion of a high-speed data communication interface 100 between a first device (Device #1) 110 and a second device (Device #2) 120. Device 110 includes a transmitter 112 which provides a differential signal to a channel 130. Device 120 includes a receiver 122 that receives the differential signal from channel 130. Channel 130 includes a blocking capacitor 132 on a positive leg of the differential signal, and a blocking capacitor 134 on a negative leg of the differential signal. Data communication interface 100 may typically include additional components, such as a receiver in device 110, an associated transmitter in device 130, and an additional channel that connects the receiver and transmitter, thereby permitting bidirectional communications between the devices, as needed or desired. Examples of data communication interface 100 may include Peripheral Component Interconnect-Express (PCIe) interfaces, or other differential signal interfaces, various single-ended data communication interfaces such as double data rate (DDR) interfaces, or the like.

Device 120 further includes a detector 124 and a sideband interface 126. In a particular embodiment, detector 124 represents a dedicated in-circuit test circuit to detect the analog signal provided by receiver 122, and to provide analysis of the received signal. For example, detector 124 may include an analog-to-digital converter (ADC) configured to provide a digital readout of the analog signal provided by receiver 122. The conversion frequency may be understood to be high enough to meaningfully capture and digitize the analog signal in order to provide the functionality of the current embodiments, as described further below. In another embodiment, detector 124 represents a portion of device 210 that is provided to detect the signal received by receiver 122, and to recover the data from the received signal. Thus detector 124 may represent a data eye detector configured to detect a data eye width and data eye height in order to discriminate the data state of the received signal. In a first case, detector 124 may represent an eye detector in a data communication path that, in addition to detecting the data in the data eye, specifically measures the data eye height and data eye width. In another case, detector 124 may represent an eye detector that is provided in addition to the eye detector in the data communication path. As such, the eye detector in the data communication path can be of a simpler design, and hence configured to draw less power, while detector 124 can be of a more robust design that draws more power, but that is only enable selectively during various circuit test operations, as described further below.

The ability to physically measure signal paths, and particularly the components that make up a high-speed data communication channels, is increasingly difficult as signaling rates continue to increase. The optical inspection of components is limited by the ability of component manufacturer to distinguish between different component types and component values. In particular, the value of the coupling capacitors of the typical differential signal channel and the correct placement of the capacitors on the PCB are critical to the performance of high-speed data communication interfaces. However, visual inspection is typically inadequate to detect misaligned components or their values.

It has been understood by the inventors of the current disclosure that high-speed data communication interfaces such as data communication interface 100 include features which may be utilized to detect the presence, mounting, and value of components in a data communication channel. Such detection may be provided during the manufacturing process for the information handling system that includes the data communication interface. For example, after a printed circuit board (PCB) that includes the data communication interface is assembled and tested, the methods described below may be utilized as a quality check for the PCB, detecting the presence, absence, or misalignment of the components of the data communication channel, and the value of the components. Further, the methods described below may be utilized during a power-on self test (POST) phase of operation of the information handling system to reverify the presence, absence, or misalignment, and value of the components of the data communication interface prior to runtime operation of the information handling system. Finally, the methods described herein may be utilized during the runtime operation of the information handling system, such as when the performance of the data communication interface is seen to be degrading over time. For example, the methods as described below may be initiated to reverify the presence, absence, or misalignment, and value of the components of the data communication interface when a bit error rate (BER) for the data communication interface exceeds a predefined threshold.

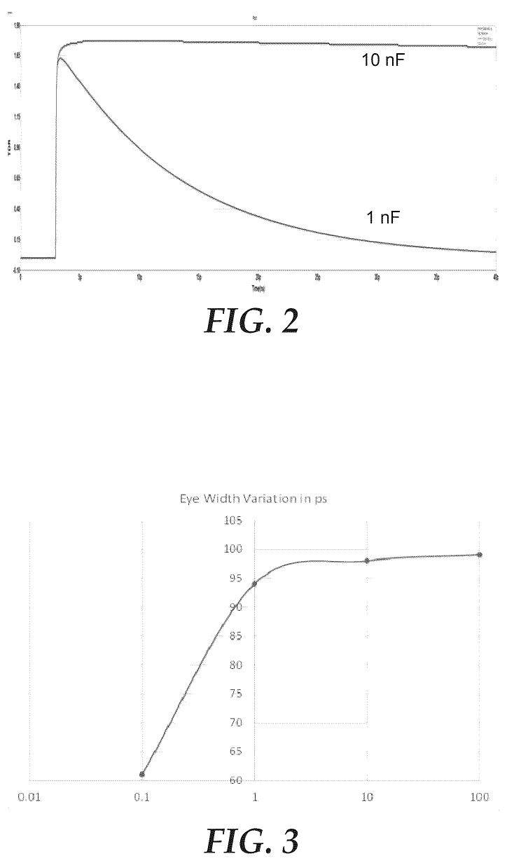

In particular, the discharge rate of blocking capacitors 132 and 134 can be determined by measuring the discharge rate of the blocking capacitors when transmitter 112 provides a step function signal on channel 130. For example, FIG. 2 illustrates the discharge signal from a 1 nano-Farad (nF) capacitor and from a 10 nF capacitor. Receiver 122 receives the step function signal on channel 130, but also, if the step function is maintained by transmitter 112 for a long enough duration, receives the discharge signal of blocking capacitors 132 and 134. The discharge signal is detected by detector 124. Where detector 124 represents an ADC, then the detector digitizes the discharge signal of blocking capacitors 132 and 134. On the other hand, where detector 124 represents a data eye detector, then the detector detects the data eye width from discharge signal. When blocking capacitors 132 and 134 have a higher value, the data eye width will be larger than when the blocking capacitors have a lower value. For example, FIG. 3 illustrates a curve correlating capacitance values (in nF) with data eye widths (in pico-seconds (ps)).

As such, data communication interface 100 operates to provide a test mode for testing the values of blocking capacitors 132 and 134, where transmitter 112 is directed to provide a test signal on channel 130 that is optimized to test the capacitance values of the blocking capacitors. Then detector 124 operates to detect the discharge signal from channel 130. Eye detector 124 is configured to provide the information related to the discharge signal to sideband interface 126. The information handling system that includes data communication interface 100 further includes a management system 140, such as a baseboard management controller, an embedded controller, or the like. Sideband interface 126 operates to communicate the discharge signal information to management system 140. Management system 140 is configured to determine the value of blocking capacitors 132 and 134 based on the discharge signal information from detector 124.

In particular, management system 140 is configured with predetermined capacitance value information, and to compare the predetermined capacitance value information with the discharge signal information to determine whether or not the capacitance values are within a tolerable limit. For example, where detector 124 represents an ADC, management system 140 receives the digitized discharge signal via sideband interface 126 and compares the digitized discharge signal with predetermined capacitance value curves to determine the capacitance value of blocking capacitors 132 and 134. Management system 140 includes an expected capacitance value for blocking capacitors 132 and 134, and provides an indication when the determined capacitance value differs from the expected capacitance value. In a particular case, management system 140 utilizes the expected capacitance value as a threshold limit, and the determined capacitance value may be expected to be greater than or less than the threshold limit, as needed or desired. In another case, management system 140 provides a tolerance around the expected capacitance value, such as a +/−5% tolerance, such that determined capacitance values that are within the tolerance are deemed acceptable, while determined capacitance values that are outside the tolerance are deemed unacceptable.

On the other hand where detector 124 represents a data eye detector, management system 140 receives the data eye width measurement via sideband interface 126 and compares the data eye width measurement with a predetermined data eye width to determine the capacitance value of blocking capacitors 132 and 134. Management system 140 includes an expected data eye width for blocking capacitors 132 and 134, and provides an indication when the data eye width differs from the expected data eye width. In a particular case, management system 140 utilizes the expected data eye width as a threshold limit, and the determined data eye width may be expected to be greater than or less than the threshold limit, as needed or desired. In another case, management system 140 provides a tolerance around the expected data eye width, such as a +/−5% tolerance, such that determined data eye widths that are within the tolerance are deemed acceptable, while determined data eye widths that are outside the tolerance are deemed unacceptable.

A method for determining the capacitance value of blocking capacitors 134 may be initiated by directing transmitter 112 to transmit a test signal to channel 130. The test signal may be a low-frequency signal, such as a 1-10 giga-bits per second (Gbps) signal for current PCIe interfaces, a pseudorandom binary sequence (PBRS) signal, or the like. In particular, the test signal may be selected to permit the full discharge of a wide range of capacitance values, for example, up to 100 nF or more. Detector then operates to provide the discharge signal information (ADC information or data eye information) to management system 140. Then management system 140 operates to analyze the discharge signal information and to determine whether the capacitance value of blocking capacitors 132 and 134 are acceptable or unacceptable, as described above.

The embodiments as described above provide for the measurement of blocking capacitors in a data communication channel. However the teachings of the current disclosure should not be limited to the measurement only of blocking capacitor values, but may be utilized to measure other component values as needed or desired. For example, channel 130 is illustrated as including no termination resistors. This may be based upon the fact that common data communication architectures provide termination resistors within devices 110 and 120. Hence a test method for testing on-device termination resistors may be provided by the manufacturer of devices 110 and 120, thereby obviating the need to have an on-board test method for the termination resistors. However, other data communication interfaces may include on-board termination resistors for the associated data communication channel. Detector 124 may similarly detect the receive signal in response to a particular test signal to evaluate the presence, absence, or placement, and value of such termination resistors, as needed or desired. As described herein, management system 140 operates to evaluate the discharge signal information from detector 124. However such a configuration is meant to be exemplary, and in various embodiments device 120 may be configured to perform said evaluation, or any portion thereof, and operates to communicate a determination as to the acceptability or unacceptability of the components thus evaluated, as needed or desired.

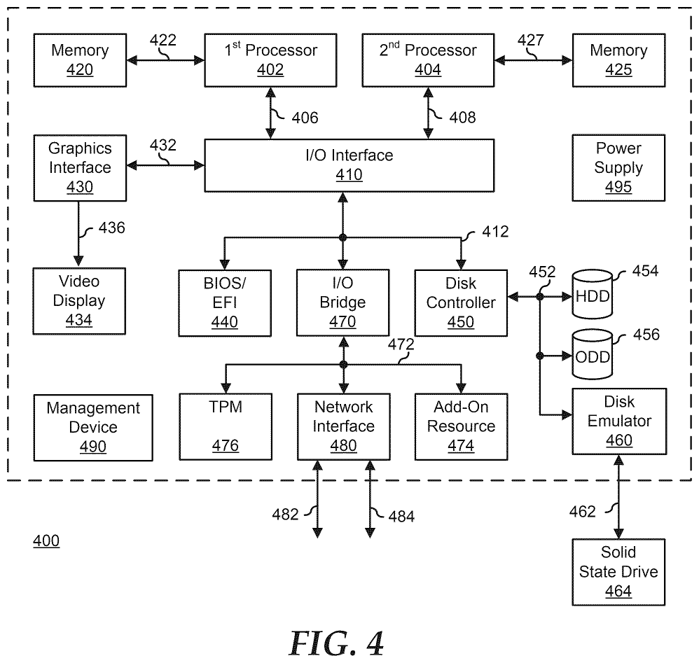

FIG. 4 illustrates a generalized embodiment of an information handling system 400 similar to information handling system 400. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 400 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 400 can include processing resources for executing machine-executable code, such as a central processing unit (CPU), a programmable logic array (PLA), an embedded device such as a System-on-a-Chip (SoC), or other control logic hardware. Information handling system 400 can also include one or more computer-readable medium for storing machine-executable code, such as software or data. Additional components of information handling system 400 can include one or more storage devices that can store machine-executable code, one or more communications ports for communicating with external devices, and various input and output (I/O) devices, such as a keyboard, a mouse, and a video display. Information handling system 400 can also include one or more buses operable to transmit information between the various hardware components.

Information handling system 400 can include devices or modules that embody one or more of the devices or modules described below, and operates to perform one or more of the methods described below. Information handling system 400 includes a processors 402 and 404, an input/output (I/O) interface 410, memories 420 and 425, a graphics interface 430, a basic input and output system/universal extensible firmware interface (BIOS/UEFI) module 440, a disk controller 450, a hard disk drive (HDD) 454, an optical disk drive (ODD) 456, a disk emulator 460 connected to an external solid state drive (SSD) 462, an I/O bridge 470, one or more add-on resources 474, a trusted platform module (TPM) 476, a network interface 480, a management device 490, and a power supply 495. Processors 402 and 404, I/O interface 410, memory 420, graphics interface 430, BIOS/UEFI module 440, disk controller 450, HDD 454, ODD 456, disk emulator 460, SSD 462, I/O bridge 470, add-on resources 474, TPM 476, and network interface 480 operate together to provide a host environment of information handling system 400 that operates to provide the data processing functionality of the information handling system. The host environment operates to execute machine-executable code, including platform BIOS/UEFI code, device firmware, operating system code, applications, programs, and the like, to perform the data processing tasks associated with information handling system 400.

In the host environment, processor 402 is connected to I/O interface 410 via processor interface 406, and processor 404 is connected to the I/O interface via processor interface 408. Memory 420 is connected to processor 402 via a memory interface 422. Memory 425 is connected to processor 404 via a memory interface 427. Graphics interface 430 is connected to I/O interface 410 via a graphics interface 432, and provides a video display output 436 to a video display 434. In a particular embodiment, information handling system 400 includes separate memories that are dedicated to each of processors 402 and 404 via separate memory interfaces. An example of memories 420 and 430 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 440, disk controller 450, and I/O bridge 470 are connected to I/O interface 410 via an I/O channel 412. An example of I/O channel 412 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 410 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/UEFI module 440 includes BIOS/UEFI code operable to detect resources within information handling system 400, to provide drivers for the resources, initialize the resources, and access the resources. BIOS/UEFI module 440 includes code that operates to detect resources within information handling system 400, to provide drivers for the resources, to initialize the resources, and to access the resources.

Disk controller 450 includes a disk interface 452 that connects the disk controller to HDD 454, to ODD 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an IEEE 1394 (Firewire) interface, a proprietary interface, or a combination thereof. Alternatively, solid-state drive 464 can be disposed within information handling system 400.

I/O bridge 470 includes a peripheral interface 472 that connects the I/O bridge to add-on resource 474, to TPM 476, and to network interface 480. Peripheral interface 472 can be the same type of interface as I/O channel 412, or can be a different type of interface. As such, I/O bridge 470 extends the capacity of I/O channel 412 where peripheral interface 472 and the I/O channel are of the same type, and the I/O bridge translates information from a format suitable to the I/O channel to a format suitable to the peripheral channel 472 where they are of a different type. Add-on resource 474 can include a data storage system, an additional graphics interface, a network interface card (NIC), a sound/video processing card, another add-on resource, or a combination thereof. Add-on resource 474 can be on a main circuit board, on separate circuit board or add-in card disposed within information handling system 400, a device that is external to the information handling system, or a combination thereof.

Network interface 480 represents a NIC disposed within information handling system 400, on a main circuit board of the information handling system, integrated onto another component such as I/O interface 410, in another suitable location, or a combination thereof. Network interface device 480 includes network channels 482 and 484 that provide interfaces to devices that are external to information handling system 400. In a particular embodiment, network channels 482 and 484 are of a different type than peripheral channel 472 and network interface 480 translates information from a format suitable to the peripheral channel to a format suitable to external devices. An example of network channels 482 and 484 includes InfiniBand channels, Fibre Channel channels, Gigabit Ethernet channels, proprietary channel architectures, or a combination thereof. Network channels 482 and 484 can be connected to external network resources (not illustrated). The network resource can include another information handling system, a data storage system, another network, a grid management system, another suitable resource, or a combination thereof.

Management device 490 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 400. In particular, management device 490 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 400, such as system cooling fans and power supplies. Management device 490 can include a network connection to an external management system, and the management device can communicate with the management system to report status information for information handling system 400, to receive BIOS/UEFI or system firmware updates, or to perform other task for managing and controlling the operation of information handling system 400. Management device 490 can operate off of a separate power plane from the components of the host environment so that the management device receives power to manage information handling system 400 where the information handling system is otherwise shut down. An example of management device 490 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 490 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed:

1. An information handling system, comprising:
a first device including a transmitter for a high-speed data communication interface; and
a second device including a receiver for the high-speed data communication interface; and
a channel coupled between the transmitter and the receiver, wherein:
the transmitter is configured to provide a test signal on the channel; and
the receiver is configured to receive the test signal from the channel, and to determine a value of a component of the channel based on the received test signal.

2. The information handling system of claim 1, wherein the component includes a blocking capacitor on the channel.

3. The information handling system of claim 2, wherein the second device further includes a detector coupled to the receiver.

4. The information handling system of claim 3, wherein the detector includes an analog-to-digital converter (ADC).

5. The information handling system of claim 4, wherein the ADC provides a digitized stream that measures a capacitive discharge of the blocking capacitor.

6. The information handling system of claim 5, wherein the receiver determines a capacitance value of the blocking capacitor based on the digitized stream of the capacitive discharge.

7. The information handling system of claim 2, wherein the detector includes a data eye detector.

8. The information handling system of claim 7, wherein the data eye detector measures an eye width of the test signal.

9. The information handling system of claim 8, wherein the receiver determines a capacitance value of the blocking capacitor based on the eye width of the test signal.

10. The information handling system of claim 1, wherein the high-speed data communication interface is a differential signal interface.

11. A method, comprising:
providing, in an information handling system, a first device including a transmitter for a high-speed data communication interface;
providing, in the information handling system, a second device including a receiver for the high-speed data communication interface;
coupling a channel between the transmitter and the receiver;
providing, by the transmitter, a test signal on the channel;
receiving, by the receiver, the test signal from the channel; and
determining a value of a component of the channel based on the received test signal.

12. The method of claim 11, wherein the component includes a blocking capacitor on the channel.

13. The method of claim 12, wherein the second device further includes a detector coupled to the receiver.

14. The method of claim 13, wherein the detector includes an analog-to-digital converter (ADC).

15. The method of claim 14, wherein the ADC provides a digitized stream that measures a capacitive discharge of the blocking capacitor.

16. The method of claim 15, wherein the receiver determines a capacitance value of the blocking capacitor based on the digitized stream of the capacitive discharge.

17. The method of claim 12, wherein the detector includes a data eye detector.

18. The method of claim 17, wherein the data eye detector measures an eye width of the test signal.

19. The method of claim 18, wherein the receiver determines a capacitance value of the blocking capacitor based on the eye width of the test signal.

20. An information handling system, comprising:
a first device including a transmitter for a high-speed differential data communication interface;
a second device including a receiver for the high-speed differential data communication interface; and
a channel coupled between the transmitter and the receiver, the channel including first and second blocking capacitors;
wherein the transmitter is configured to provide a test signal on the channel; and the receiver is configured to receive the test signal from the channel, and to determine a value of at least one of the first and second blocking capacitors based on the received test signal.
